(19) United States
(12) Patent Application Publication
(10) Pub. No.: US 2013/0126100 A1
(43) Pub. Date: May 23, 2013

(54) SHEET SEPARATION APPARATUS AND SEPARATION METHOD, AND SHEET ATTACHING APPARATUS AND ATTACHING METHOD

(71) Applicant: Toshihiro Fujita, Tokyo (JP)

(72) Inventor: Toshihiro Fujita, Tokyo (JP)

(73) Assignee: LINTEC CORPORATION, Tokyo (JP)

(21) Appl. No.: 13/813,845

(22) PCT Filed: Jun. 30, 2011
(86) PCT No.: PCT/JP2011/065061

§ 371 Date: Feb. 1, 2013

(30) Foreign Application Priority Data
Aug. 10, 2010 (JP) 2010-179596

(51) Int. Cl. B32B 43/00; B29C 63/00

(52) U.S. Cl. CPC B32B 43/006
USPC 156/719; 156/764; 156/758

(57) ABSTRACT

A sheet peeling device includes: a feeder that feeds a material sheet and a peeling unit that peels the adhesive sheet from the peeling sheet. The peeling unit includes: a peeling member having a bending edge for folding back the peeling sheet; and a following unit that forms an anti-bending area with irregularities at least on the adhesive sheet in the feeding direction. The peeling member includes a guide surface continuous to the bending edge and guides the material sheet; and a first irregularity formed on the guide surface in the feeding direction and is open on the bending edge. The following unit includes a guide member interposing the material sheet with the peeling member and having a second irregularity to fit to the first irregularity. The second irregularity includes a convex portion that extends to the bending edge in the feeding direction corresponding to the first irregularity.

### TECHNICAL FIELD

The present invention relates to a sheet peeling apparatus and a peeling method, and a sheet sticking apparatus and a sticking method.

### BACKGROUND ART

In a peeling apparatus and a sticking apparatus that feed a raw sheet on which an adhesive sheet is temporarily stuck on one surface of a belt-like release liner and peel the adhesive sheet from the release liner of the fed raw sheet, such a peeling apparatus and a sticking apparatus that reliably peel the adhesive sheet from the release liner even when a temporary adhesive power of the adhesive sheet to the release liner is strong have been typically known (see, for instance, Patent Literature 1).

The peeling apparatus disclosed in Patent Literature 1 peels the adhesive sheet, which is temporarily stuck on the release liner widthwise divided in half in advance, from the release liner. The peeling apparatus peels the adhesive sheet from the release liner by diagonally folding the release liner at an inclined edge of a peeling plate to turn the release liner in a lateral direction relative to the feeding direction.

### CITATION LIST

### Patent Literature(s)

Patent Literature 1 JP-A-2006-143290

### SUMMARY OF THE INVENTION

### Problems to be Solved by the Invention

However, in the peeling apparatus disclosed in Patent Literature 1, two release liners are turned in different directions, in other words, the release liners are fed in right-and-left directions relative to the feeding direction. Since the release liners also need to be subsequently turned in different directions for plural times, the apparatus becomes complicated in structure and enlarged in an overall size, and a raw sheet including a release liner widthwise divided in half in advance is only applicable.

An object of the invention is to provide a simply structured sheet peeling apparatus capable of reliably peeling an adhesive sheet and a peeling method thereof, and a sheet sticking apparatus and a sticking method thereof.

### Means for Solving the Problems

In order to achieve the object, according to an aspect of the invention, in a sheet peeling apparatus that peels an adhesive sheet from a raw sheet, the adhesive sheet comprising a base sheet and an adhesive layer provided on one surface of the base sheet, the raw sheet including the adhesive sheet and a belt-like release liner to which the adhesive sheet is temporarily stuck through the adhesive layer, the sheet peeling apparatus includes: a feeder that feeds the raw sheet; and a peeling unit that folds back the release liner of the fed raw sheet to peel the adhesive sheet from the release liner, the peeling unit including: a peeling member having a bending edge for folding back the release liner; and a following unit that forms an anti-bending area with irregularities in a feeding direction at least on the adhesive sheet of the raw sheet by conforming the raw sheet with a shape of the peeling member, the peeling member including: a guide surface that is continuous to the bending edge and guides the raw sheet through the release liner, and a first irregularity that is formed on the guide surface in the feeding direction of the raw sheet and is open on the bending edge, the following unit including: a guide member that is disposed opposite to the peeling member with the raw sheet interposed between the guide member and the peeling member and includes a second irregularity to fit to the first irregularity, in which the second irregularity comprises a convex portion that extends to the bending edge in the feeding direction, corresponding to the first irregularity.

In the sheet peeling apparatus according to the above aspect of the invention, it is preferable to further include a driving device capable of adjusting a distance between the peeling member and the guide member.

In the sheet peeling apparatus according to the above aspect of the invention, it is preferable that the first irregularity is a groove formed on the guide surface and having an open end on the bending edge, and the second irregularity extends to a position opposite to the groove in the bending edge with the raw sheet interposed between the second irregularity and the groove.

In the sheet peeling apparatus according to the above aspect of the invention, it is preferable that the peeling member includes a suction unit having a suction hole for sucking the release liner of the raw sheet, the first irregularity is a groove formed in the guide surface, and the suction hole is provided in the groove.

According to another aspect of the invention, in a sheet peeling method of peeling an adhesive sheet from a raw sheet, the adhesive sheet including a base sheet and an adhesive layer provided on one surface of the base sheet, the raw sheet including the adhesive sheet and a belt-like release liner to which the adhesive sheet is temporarily stuck through the adhesive layer, the sheet peeling method includes: feeding the raw sheet between a guide surface having a first irregularity formed in a feeding direction of the raw sheet and a guide member having a second irregularity extending to a bending edge in a manner to correspond to the first irregularity in the feeding direction and fit to the first irregularity to form an anti-bending area with irregularities at least on the adhesive sheet of the raw sheet in the feeding direction; and folding back the release liner on the bending edge to peel the adhesive sheet from the release liner.

According to still another aspect of the invention, in a sheet sticking apparatus that peels an adhesive sheet from a raw sheet, the adhesive sheet including a base sheet and an adhesive layer provided on one surface of the base sheet, the raw sheet including the adhesive sheet and a belt-like release liner to which the adhesive sheet is temporarily stuck through the adhesive layer, the sheet sticking apparatus includes: a feeder that feeds the raw sheet; a peeling unit that folds back the release liner of the fed raw sheet to peel the adhesive sheet from the release liner; and a press unit that presses and sticks the peeled adhesive sheet on the adherend, the peeling unit including: a peeling member having a bending edge for folding back the release liner; and a following unit that forms an anti-bending area with irregularities in a feeding direction at least on the adhesive sheet of the raw sheet by conforming the raw sheet with a shape of the peeling member, the peeling member including: a guide surface that is continuous to the bending edge and guides the raw sheet on a side of the release liner, and a first irregularity that is formed on the guide surface in the feeding direction of the raw sheet and is open on the bending edge, the following unit including: a guide member that is disposed opposite to the peeling member with the raw sheet interposed between the guide member and the peeling member and includes a second irregularity to fit to the first irregularity, in which the second irregularity comprises a convex portion that extends to the bending edge in the feeding direction, corresponding to the first irregularity.

According to a further aspect of the invention, in a sheet sticking method of peeling an adhesive sheet from a raw sheet, the adhesive sheet including a base sheet and an adhesive layer provided on one surface of the base sheet, the raw sheet including the adhesive sheet and a belt-like release liner to which the adhesive sheet is temporarily stuck through the adhesive layer, the sheet sticking method includes: feeding the raw sheet between a guide surface having a first irregularity formed in a feeding direction of the raw sheet and a guide member having a second irregularity extending to a bending edge in a manner to correspond to the first irregularity in the feeding direction and fit to the first irregularity to form an anti-bending area with irregularities at least on the adhesive sheet of the raw sheet in the feeding direction; folding back the release liner on the bending edge to peel the adhesive sheet from the release liner; and pressing and sticking the peeled adhesive sheet on the adherend.

### Advantages of the Invention

According to the above aspects of the invention, since the anti-bending area with irregularities is formed on the adhesive sheet in the feeding direction, bending rigidity of the adhesive sheet in the feeding direction can be improved. Accordingly, the adhesive sheet can resist a bending force of the release liner when folding the release liner. For instance, when an adhesive agent of the adhesive sheet penetrates in a punch hole of the release liner which is formed after the adhesive sheet is cut out in a predetermined shape, or when a sealant (e.g., varnish) is coated on an outer edge of the adhesive sheet to avoid the adhesive agent of the adhesive sheet from exuding, where a temporary adhesive power of the adhesive sheet to the release liner is extremely strong, the adhesive sheet can be reliably peeled from the release liner. Moreover, since it is not necessary to feed the release liner in the right-and-left directions relative to the feeding direction unlike typical examples of the apparatus, it can be avoided that the apparatus becomes complicated in structure and enlarged in the overall size. In addition, a raw sheet having no release liner widthwise divided in half in advance is applicable. Accordingly, the apparatus with a simple structure can reliably peel the adhesive sheet from the release liner.

In the above aspects of the invention, with an arrangement that the raw sheet is interposed between the peeling unit and the following unit, which is the second irregularity disposed opposite to the peeling member, to conform with the shape of the peeling member, the anti-bending area can be formed on the adhesive sheet only by feeding the raw sheet. Accordingly, with a simple structure, the adhesive sheet can be reliably peeled from the release liner.

Moreover, in the above aspects of the invention, by sucking the raw sheet through the release liner, or ejecting gas toward the raw sheet so that the raw sheet conforms with the shape of the peeling member, the anti-bending area can be formed without contacting the adhesive sheet.

### BRIEF DESCRIPTION OF DRAWINGS

FIG. 1 is a side view of a sheet sticking apparatus according to a first exemplary embodiment of the invention.

FIG. 2 is a fragmentary perspective view of the sheet sticking apparatus in FIG. 1.

FIG. 3 is a perspective view of a peeling unit of the sheet sticking apparatus in FIG. 1.

FIG. 4 is a perspective view of a peeling unit of a sheet sticking apparatus according to a second exemplary embodiment of the invention.

FIG. 5 is a side view of a sheet sticking apparatus according to a third exemplary embodiment of the invention.

FIG. 6 is a side view of a sheet sticking apparatus according to a fourth exemplary embodiment of the invention.

FIG. 7 is a perspective view of a modification of the invention shown in the same manner as in FIG. 3.

### DESCRIPTION OF EMBODIMENT(S)

Exemplary embodiment (s) of the invention will be described below with reference to the attached drawings.

In a second exemplary embodiment and subsequent ones, the same components or components having similar functions as components described later in a first exemplary embodiment will be denoted by the same reference numerals of those in the first exemplary embodiment, and the description thereof will be omitted or simplified.

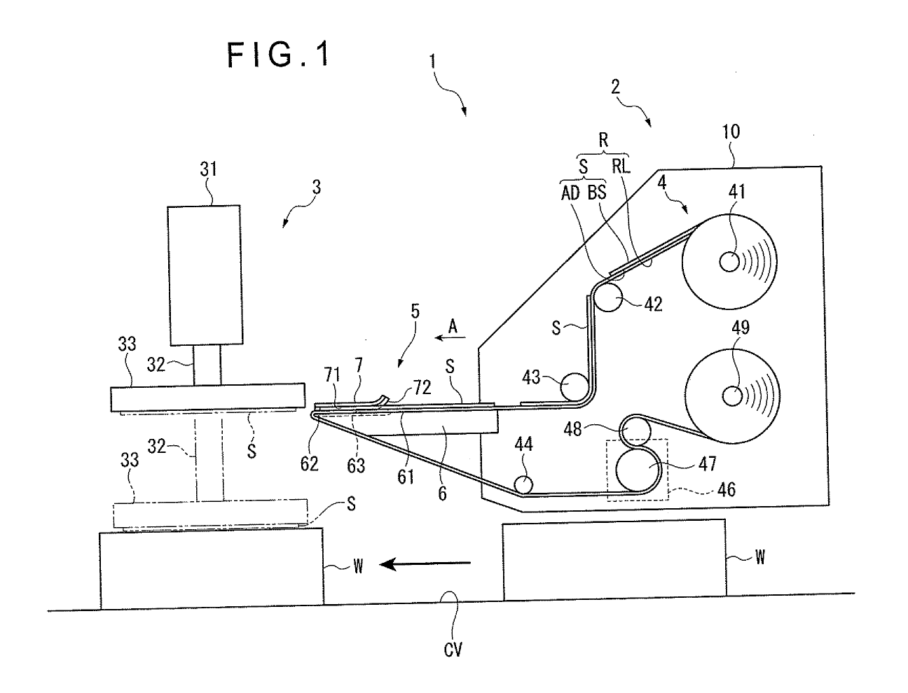

All expressions indicating directions such as “up, down, left, right, front and back” which are not explicitly defined in the exemplary embodiments will be used with reference to FIG. 1.

### First Exemplary Embodiment

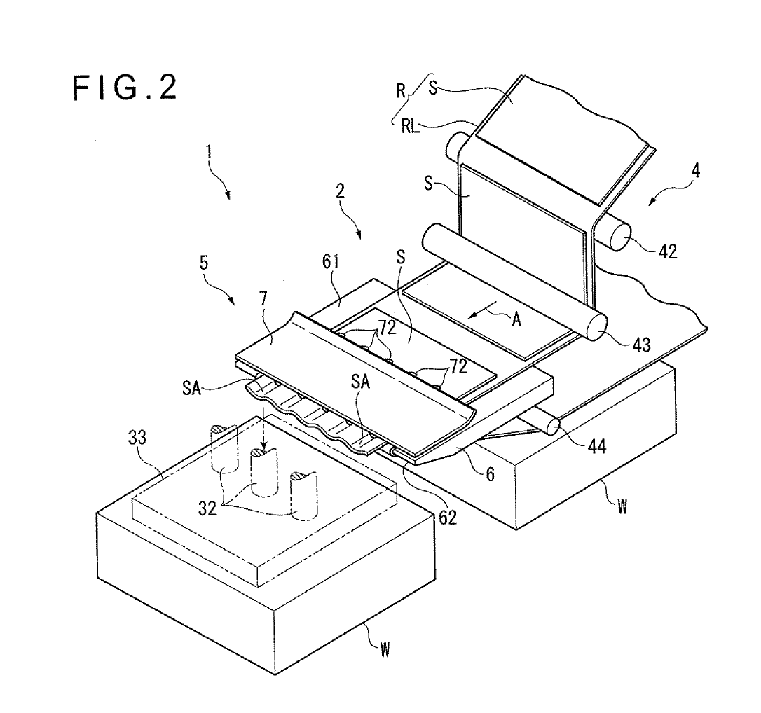

As shown in FIGS. 1 and 2, a sheet sticking apparatus 1 in this exemplary embodiment peels an adhesive sheet S, which is temporarily stuck to one of surfaces of a belt-like release liner RL, from the release liner RL and sticks the peeled adhesive sheet S to an adherend W. Herein, the adhesive sheet S includes a base sheet BS and an adhesive layer AD laminated on one of surfaces of the base sheet BS, and is temporarily stuck to the one of the surfaces of the release liner RL via the adhesive layer AD to prepare a raw sheet R in advance.

The sheet sticking apparatus 1 includes: a sheet peeling apparatus 2 that peels the adhesive sheet S from the release liner RL of the raw sheet R; and a press unit 3 that presses the peeled adhesive sheet S onto the adherend W for adhesion. The sheet peeling apparatus 2 includes: a feeder 4 that feeds the raw sheet R; and a peeling unit 5 that peels the adhesive sheet S from the release liner RL by folding back the release liner RL of the fed raw sheet R.

The feeder 4 is entirely supported by a frame 10. The feeder 4 includes: a support roller 41 that rolls the raw sheet R therearound and supports the raw sheet R; guide rollers 42 and 43 that guide the raw sheet R; a guide roller 44 that guides the release liner RL from which the adhesive sheet S is already peeled; a drive roller 47 that is driven by a rotary motor 46 (i.e., a driving device); a pinch roller 48 that interposes the release liner RL with the drive roller 47; and a collecting roller 49 that collects the release liner RL, driven by a driving device (not shown).

The peeling unit 5 includes; a peel plate 6 (i.e., a peeling member) that folds back the release liner RL of the fed raw sheet R; and a guide member 7 (i.e., a following unit) that is located opposite to the peel plate 6 and interposes the raw sheet R with the peel plate 6.

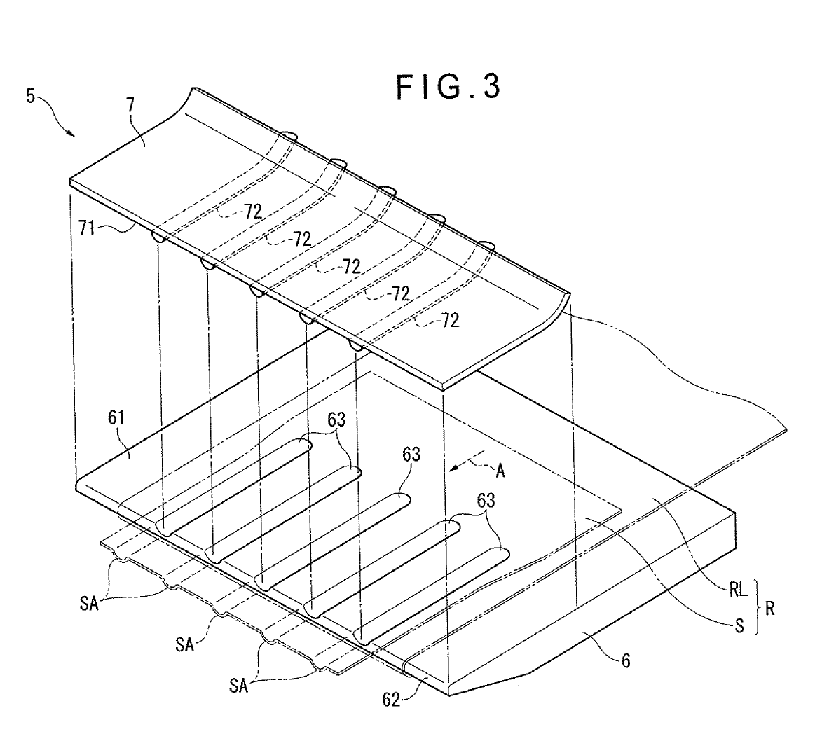

As shown in FIG. 3, the peel plate 6 includes: a guide surface 61 that guides the raw sheet R through the release liner RL; a bending edge 62 of the guide surface 61 that is located on a downstream side in a feeding direction of the raw sheet R and bends the release liner RL; and a plurality of grooves 63 (a first irregularity) that are formed on the guide surface 61 in the feeding direction A of the raw sheet R and are opened at the bending edge 62. The grooves 63 serve as an anti-bending area formation unit, whereby an anti-bending area SA with irregularities is formable in the feeding direction A at least on the adhesive sheet S in the raw sheet R.

The guide member 7 is located opposite to the guide surface 61 with the raw sheet R interposed between the guide member 7 and the guide surface 61. The guide member 7 includes a plurality of convex portions 72 (a second irregularity) that are fit to the grooves 63 with the raw sheet R interposed between the convex portions 72 and the grooves 63; and a support plate 71 that supports the convex portions 72. An end of the support plate 71 on an upstream side in the feeding direction of the raw sheet R is bent together with the convex portions 72 in a direction separating from the peel plate 6, whereby a tip end of the adhesive sheet S in the feeding direction is prevented from being caught by the convex portions 72 when the adhesive sheet S is inserted between the peel plate 6 and the guide member 7. The peel plate 6 and the guide member 7 are provided in a manner relatively movable toward or away from each other via a driving device (not shown), whereby a distance between the peel plate 6 and the guide member 7 is adjustable. With this arrangement, the raw sheet R, even having a variety of thicknesses, can be easily inserted. Moreover, the peel plate 6 and the guide member 7 may be arranged to move away from each other via the driving device (not shown) after the tip end of the adhesive sheet S in the feeding direction is peeled from the release liner RL. With this arrangement, possible damage on the adhesive sheet S by the convex portions 72 can be reduced.

The press unit 3 includes: a linear movement motor 31 (i.e., a driving device) supported by a frame (not shown): and a suction pad 33 fixed to an output shaft 32 of the linear movement motor 31. The suction pad 33 has a plurality of suction holes (not shown) and can suck and hold the adhesive sheet S through the base sheet BS with the suction holes.

In the sheet sticking apparatus 1, processes of peeling the adhesive sheet S from the release liner RL and sticking the peeled adhesive sheet S on the adherend W will be described.

Firstly, as shown in FIG. 1, the raw sheet R is inserted and the feeder 4 drives the rotary motor 46 to rotate the drive roller 47, thereby feeding the raw sheet R. Subsequently, the fed raw sheet R is guided in the feeding direction A along the guide surface 61 of the peel plate 6 and the guide member 7, so that the tip end of the adhesive sheet S in the feeding direction reaches the grooves 63 and the convex portions 72.

Subsequently, by continuous feeding of the raw sheet R, an adhesive sheet that is a portion of the raw sheet R passes between the grooves 63 and the convex portions 72. Consequently, the raw sheet R conforms with shapes of the grooves 63 and the convex portions 72, so that the tip end of the adhesive sheet S in the feeding direction is deformed in a wavy shape to form a plurality of anti-bending areas SA with irregularities on the adhesive sheet S in the feeding direction A. When the tip end of the adhesive sheet S in the feeding direction comes close to the bending edge 62 of the peel plate 6, as shown in a solid line in FIG. 1, the feeding of the raw sheet R is temporarily stopped and is brought into a stand-by state.

Next, when the adherend W is delivered on a delivery path CV such a conveyor belt, the adherend W is detected by a sensor (not shown) and stopped at a predetermined position under the suction pad 33. When stopping of the adherend W is confirmed, the sheet sticking apparatus 1 provides feeding power to the raw sheet R by the rotary motor 46 in the same manner as described above, thereby feeding the adhesive sheet S. At this time, the bending rigidity of the adhesive sheet S in the feeding direction A is enhanced since the anti-bending areas SA are formed on the adhesive sheet S. With this arrangement, even when the temporary adhesive power of the adhesive sheet S to the release liner RL is extremely strong, the adhesive sheet S is not bent on the bending edge 62 together with the release liner RL and does not proceed toward the guide roller 44. Rather, the adhesive sheet S is fed from the bending edge 62 toward the suction pad 33 with resisting the bending force of the release liner RL, is reliably peeled from the release liner RL, and is sucked and held by the suction of the suction pad 33

The linear movement motor 31 lowers the suction pad 33, brings an adhesive surface of the adhesive sheet S into contact with the adherend W, and presses the adhesive sheet S on the adherend W.

When the adhesive sheet S is stuck on the adherend W as described above, after the sheet sticking apparatus 1 releases the suction pad 33 from adsorbing and holding the adhesive sheet S, the sheet sticking apparatus 1 elevates the suction pad 33 by the linear movement motor 31 and returns each portion to an original position. With this operation, adhesion of the peeled adhesive sheet S on the adherend W is completed. The same operation is repeated afterward.

According to the above-described exemplary embodiment, the following advantages can be obtained.

Since the sheet sticking apparatus 1 provides the anti-bending areas SA with irregularities in the feeding direction on the adhesive sheet S of the raw sheet R by conforming the raw sheet R with the shape of the peel plate 6, the bending rigidity of the adhesive sheet S in the feeding direction A can be improved. Accordingly, even when the temporary adhesive power to the release liner RL of the adhesive sheet S of the raw sheet R is extremely strong, the adhesive sheet S can resist against folding movement of the release liner RL when the release liner RL is folded back, so that the adhesive sheet S can be reliably peeled off from the release liner RL. Moreover, since it is not necessary to feed the release liner RL in right-and-left directions relative to the feeding direction A, a structure of the sheet sticking apparatus 1 can be simplified.

### Second Exemplary Embodiment

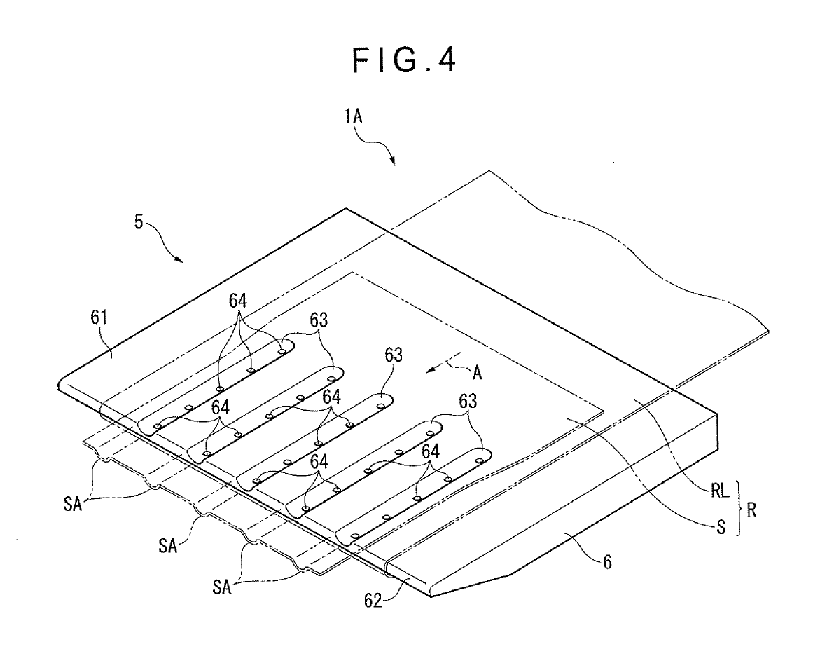

Next, a second exemplary embodiment of the invention will be described below with reference to FIG. 4.

The peeling unit 5 of a sheet sticking apparatus 1 A in this exemplary embodiment is only different from the first exemplary embodiment in that the guide member 7 is replaced by suction holes 64 serving as a following unit. Accordingly, the overall figure is omitted. In the sheet sticking apparatus 1 A, the raw sheet R is sucked toward the peel plate 6, whereby a plurality of anti-bending areas SA with irregularities are formed on the adhesive sheet S in the feeding direction A.

Specifically, a plurality of suction holes 64 are provided in the grooves 63 of the peel plate 6 and connected to a suction device such as a decompression pump (not shown). Also in the sheet sticking apparatus 1A having such a peeling unit 5, since the anti-bending areas SA are formed on the adhesive sheet S, the bending rigidity of the adhesive sheet S in the feeding direction A becomes high, so that the adhesive sheet S is reliably peeled off from the release liner RL while resisting against a folding force of the release liner RL. In this arrangement, the anti-bending areas SA can be formed on the adhesive sheet S in no contact with other components, so that damage on the adhesive sheet S can be prevented.

### Third Exemplary Embodiment

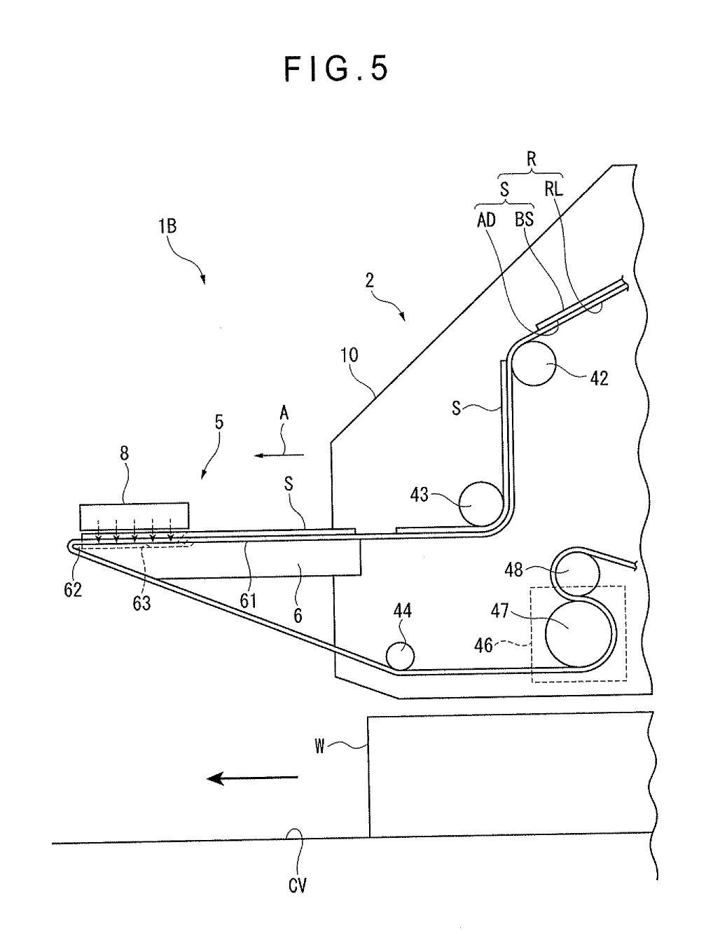

Next, a third exemplary embodiment of the invention will be described below with reference to FIG. 5.

The peeling unit 5 of a sheet sticking apparatus 1B in this exemplary embodiment is only different from that in the first exemplary embodiment in that the guide member 7 is replaced by a gas ejector 8 serving as a following unit.

Specifically, the peeling unit 5 includes: the peel plate 6; and the gas ejector 8 opposite to the peel plate 6 with the raw sheet R interposed therebetween. The gas ejector 8 includes a plurality of ejection holes (not shown) that are open toward the adhesive sheet S and ejects gas toward the raw sheet R.

Also in the above sheet sticking apparatus 1B, since the anti-bending areas SA are formed on the adhesive sheet S by gas ejection from the gas ejector 8, the adhesive sheet S is reliably peeled off from the release liner RL. In this arrangement, in fanning the anti-bending areas SA, the adhesive sheet S is in no direct contact with other components but air, so that damage on the adhesive sheet S can be prevented.

### Fourth Exemplary Embodiment

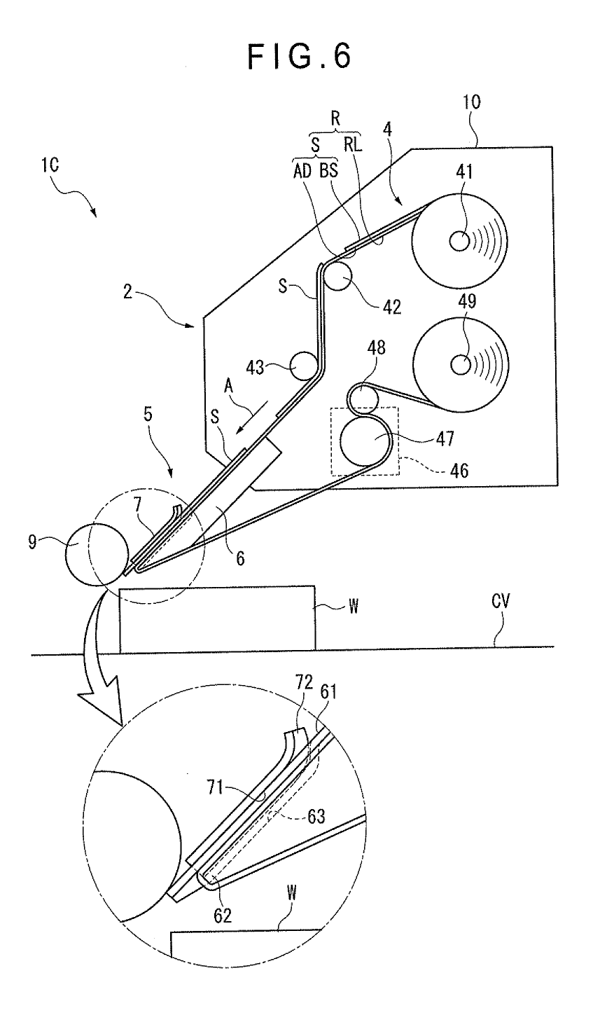

Next, a fourth exemplary embodiment of the invention will be described below with reference to FIG. 6.

A sheet sticking apparatus 1C in this exemplary embodiment is different from those in the first to third exemplary embodiments in that the press unit 3 is replaced by a press roller 9 serving as a press unit.

Specifically, the sheet sticking apparatus 1C in this exemplary embodiment includes the sheet peeling apparatus 2 and the press roller 9, in which the sheet peeling apparatus 2 includes the feeder 4 and the peeling unit 5 of any one of those in the first to third exemplary embodiments (FIG. 6 shows the peeling unit 5 of the first exemplary embodiment). The press roller 9 is made of an elastically deformable member such as rubber and resins and is rotatably supported by a frame (not shown).

In the above sheet sticking apparatus 1 C, when a sensor (not shown) detects that the adherend W on the delivery path CV reaches a predetermined position under the peel plate 6, the sheet sticking apparatus IC drives the rotary motor 46 to rotate the drive roller 47 and feeds the raw sheet R in synchronization with the movement of the delivery path CV. Since the plurality of anti-bending areas SA with irregularities are formed on the adhesive sheet S in the feeding direction A, the bending rigidity of the adhesive sheet Sin the feeding direction A becomes high, so that the adhesive sheet S is reliably peeled off from the release liner RL. The peeled adhesive sheet S is pressed and stuck on an upper surface of the adherend W by the press roller 9.

Although the best arrangement and method for implementing the invention has been disclosed above, the invention is not limited thereto. In other words, while the invention has been described with reference to the specific embodiments and the drawings thereof, various modifications may be made on shapes, materials, quantities and other specific configurations to the disclosed exemplary embodiments by those of ordinary skill in the art without departing from the spirit and scope of the invention. The description limiting the shapes and the materials disclosed above is intended to be illustrative for easier understanding and not to limit the invention, hence the invention includes the description using a name of component without a part of or all of the limitation on the shape and the material etc.

For instance, the grooves 63 and the following unit in the peeling unit 5 may be or may not be provided to have a width corresponding to an entire width of the adhesive sheet S. In other words, when a width of an initial peeling area in a form of an ellipse, circle, rhombus and the like is smaller than the entire width of the adhesive sheet S, the grooves 63 and the following unit may not necessarily be a deformation unit having a width corresponding to the entire width of the adhesive sheet S. This is because, once the initial peeling area of the adhesive sheet S is peeled off, the other areas thereof can be easily peeled off. When the width of the initial peeling area of the adhesive sheet S is narrow as in the above, a single groove 63 and a single convex portion 72, not plural ones, may be sufficient for peeling the initial peeling area. In this arrangement, the suction holes 64 and the ejection holes (not shown) of the following unit may be positioned corresponding to the shape of the groove 63.

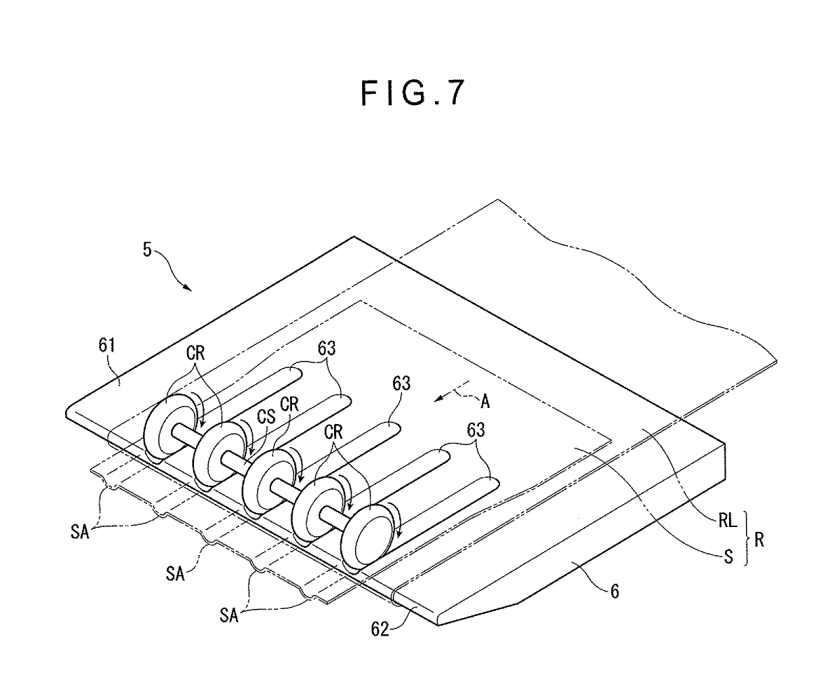

Alternatively, as shown in FIG. 7, the guide member 7 may be replaced by a following unit including: a rotary shaft CS extending in a direction perpendicular to the feeding direction A of the adhesive sheet S and parallel to the guide surface 61; and a roller CR rotating in conjunction with feeding of the raw sheet R. In this arrangement, adhesive sheet S can be prevented from being rubbed.

Further, the following unit is not requisite. When a feeding power is applied to the raw sheet R, the raw sheet R receives tension. The tension and the anti-bending area formation unit form an anti-bending area on the raw sheet R, although the anti-bending area is quite small as compared with the case where the following unit is provided.

In the above exemplary embodiments, the anti-bending area formation unit is provided on the peel plate 6 by forming the groove(s) 63. However, on the contrary, the anti-bending area formation unit may be provided by forming a convex portion in a reverse shape to the groove, or both the groove 63 and the convex portion. Further, on the peel plate 6, the groove 63 may extend from the bending edge 62 to an edge on the upstream side of the raw sheet R in the feeding direction.

For easy formation of the anti-bending areas SA, a heating unit such as a coil heater and an infrared heater may be provided within the peel plate 6, or the gas ejector 8 may eject heated gas.

The first to third exemplary embodiments show that the suction pad 33 of the press unit 3 temporarily holds the adhesive sheet S, which is peeled from the release liner RL by the peeling unit 5, and that the press unit 3 presses and sticks the adhesive sheet S held by the suction pad 33 on the adherend W. However, the press unit may alternatively be, for instance, a so-called air-jet type press unit that blows out the adhesive sheet S held by the suction pad 33 with compression air to stick the adhesive sheet S on the adherend.

The driving device in the above exemplary embodiments may be provided by: motorized equipment such as a rotary motor, linear movement motor, linear motor, single-spindle robot and multi-joint robot; an actuator such as an air cylinder, hydraulic cylinder, rodless cylinder and rotary cylinder; and a direct or indirect combination thereof (some of the driving devices overlap with the exemplified driving devices in the exemplary embodiments).

In the above exemplary embodiments, specific examples of the adherend W and the adhesive sheet S are not shown. In the sheet sticking apparatus and the sticking method, kinds and materials of the adherend W and the adhesive sheet S are not particularly limited. For instance, the adherend W may be an appropriate article (e.g., a corrugated carton and a resin container) while the adhesive sheet S may be a label, or the adherend W may be a semiconductor wafer while the adhesive sheet S may be a protection sheet, dicing tape, die attach film and the like. Here, the semiconductor is exemplified by a silicon semiconductor wafer and a compound semiconductor wafer. An adhesive sheet to be stuck on such a semiconductor wafer is not limited to the protection sheet, dicing tape and die attach film, but may be applicable to any other sheet, film, tape and the like, and to an adhesive sheet and the like having any shape for any application. Further, the adherend W is a substrate for an optical disc while the adhesive sheet S may have a resin layer for forming a record layer. As described above, the adherend W may be not only a glass plate, steel plate, resin plate and other plate-like member, but also members and articles in any form.

### Explanation of Codes

1, 1A-1C: sheet sticking apparatus

2: sheet peeling apparatus

3: press unit

4: feeder

5: peeling unit

6: peel plate (peeling member)

7: guide member (following unit)

8: gas ejector (following unit)

9: press roller (press unit)

61: guide surface

62: bending edge

63: groove (first irregularity, anti-bending area formation unit)

64: suction hole (sucking unit, following unit)

71: support plate

72: convex portion (second irregularity)

AD: adhesive layer

BS: base sheet

R: raw sheet

RL: release liner

S: adhesive sheet

SA: anti-bending area

W: adherend

1. A sheet peeling apparatus that peels an adhesive sheet from a raw sheet, the adhesive sheet comprising a base sheet and an adhesive layer provided on one surface of the base sheet, the raw sheet comprising the adhesive sheet and a belt-like release liner to which the adhesive sheet is temporarily stuck through the adhesive layer, the sheet peeling apparatus comprising:
a feeder that feeds the raw sheet; and
a peeling unit that folds back the release liner of the fed raw sheet to peel the adhesive sheet from the release liner,
the peeling unit comprising:
a peeling member having a bending edge for folding back the release liner; and
a following unit that forms an anti-bending area with irregularities in a feeding direction at least on the adhesive sheet of the raw sheet by conforming the raw sheet with a shape of the peeling member,
the peeling member comprising:
a guide surface that is continuous to the bending edge and guides the raw sheet through the release liner, and
a first irregularity that is formed on the guide surface in the feeding direction of the raw sheet and is open on the bending edge,
the following unit comprising:
a guide member that is disposed opposite to the peeling member with the raw sheet interposed between the guide member and the peeling member and comprises a second irregularity to fit to the first irregularity, wherein
the second irregularity comprises a convex portion that extends to the bending edge in the feeding direction, corresponding to the first irregularity.

2. The sheet peeling apparatus according to claim 1, further comprising a driving device capable of adjusting a distance between the peeling member and the guide member.

3. The sheet peeling apparatus according to claim 1, wherein
the first irregularity is a groove formed on the guide surface and having an open end on the bending edge, and
the second irregularity extends to a position opposite to the groove in the bending edge with the raw sheet interposed between the second irregularity and the groove.

4. The sheet peeling apparatus according to claim 1, wherein
the peeling member comprises a suction unit having a suction hole for sucking the release liner of the raw sheet,
the first irregularity is a groove formed in the guide surface, and
the suction hole is provided in the groove.

5. A sheet peeling method of peeling an adhesive sheet from a raw sheet, the adhesive sheet comprising a base sheet and an adhesive layer provided on one surface of the base sheet, the raw sheet comprising the adhesive sheet and a belt-like release liner to which the adhesive sheet is temporarily stuck through the adhesive layer, the sheet peeling method comprising:
feeding the raw sheet between a guide surface having a first irregularity formed in a feeding direction of the raw sheet and a guide member having a second irregularity extending to a bending edge in a manner to correspond to the first irregularity in the feeding direction and fit to the first irregularity to form an anti-bending area with irregularities at least on the adhesive sheet of the raw sheet in the feeding direction; and
folding back the release liner on the bending edge to peel the adhesive sheet from the release liner.

6. A sheet sticking apparatus that peels an adhesive sheet from a raw sheet, the adhesive sheet comprising a base sheet and an adhesive layer provided on one surface of the base sheet, the raw sheet comprising the adhesive sheet and a belt-like release liner to which the adhesive sheet is temporarily stuck through the adhesive layer, the sheet sticking apparatus comprising:
a feeder that feeds the raw sheet;
a peeling unit that folds back the release liner of the fed raw sheet to peel the adhesive sheet from the release liner; and
a press unit that presses and sticks the peeled adhesive sheet on the adhered,
the peeling unit comprising:
a peeling member having a bending edge for folding back the release liner; and
a following unit that forms an anti-bending area with irregularities in a feeding direction at least on the adhesive sheet of the raw sheet by conforming the raw sheet with a shape of the peeling member,
the peeling member comprising:
a guide surface that is continuous to the bending edge and guides the raw sheet on a side of the release liner, and
a first irregularity that is formed on the guide surface in the feeding direction of the raw sheet and is open on the bending edge,
the following unit comprising:
a guide member that is disposed opposite to the peeling member with the raw sheet interposed between the guide member and the peeling member and comprises a second irregularity to fit to the first irregularity, wherein
the second irregularity comprises a convex portion that extends to the bending edge in the feeding direction, corresponding to the first irregularity.

7. A sheet sticking method of peeling an adhesive sheet from a raw sheet, the adhesive sheet comprising a base sheet and an adhesive layer provided on one surface of the base sheet, the raw sheet comprising the adhesive sheet and a belt-like release liner to which the adhesive sheet is temporarily stuck through the adhesive layer, the sheet sticking method comprising:
feeding the raw sheet between a guide surface having a first irregularity formed in a feeding direction of the raw sheet and a guide member having a second irregularity extending to a bending edge in a manner to correspond to the first irregularity in the feeding direction and fit to the first irregularity to form an anti-bending area with irregularities at least on the adhesive sheet of the raw sheet in the feeding direction;
folding back the release liner on the bending edge to peel the adhesive sheet from the release liner; and
pressing and sticking the peeled adhesive sheet on the adhered.
